(19) United States
(12) Patent Application Publication
(10) Pub. No.: US 2016/0342510 A1
(43) Pub. Date: Nov. 24, 2016

(54) REMOTE MANAGEMENT OF DATA PLANES AND CONFIGURATION OF NETWORKING DEVICES

(71) Applicant: Ayaskant Pani, Fremont, CA (US)

(72) Inventor: Ayaskant Pani, Fremont, CA (US)

(73) Assignee: GOOGLE INC., Mountain View, CA (US)

(21) Appl. No.: 13/351,320

(22) Filed: Jan. 17, 2012

(51) Int. Cl. G06F 15/177; G06F 15/167

(52) U.S. Cl. CPC G06F 12/0608

(57) ABSTRACT

The subject disclosure relates to implementing a device to remotely manage the data plane and configure memory components (e.g., a forwarding table, ternary content-addressable memory, etc.) on one or more application-specific integrated circuit (ASIC) based devices. The one or more ASIC based devices can be configured, for example, based on flow information collected from the OFA (open flow agent) in conjunction with the memory map of the memory components on the one or more ASIC based devices. A state of the memory components on the one or more ASIC based devices can also be remotely monitored.

### TECHNICAL FIELD

The subject disclosure relates to networking devices and, more particularly, to remotely managing data planes and configuration of networking devices.

### BACKGROUND

Routing data between networking devices in a network is typically achieved by implementing a control plane and a data plane. The control plane manages (or handles) complex protocol tasks associated with networking. For example, the control plane performs the functions of route learning, address learning, policy rule compilation, etc. The data plane handles common data tasks for the network related to packet forwarding. Various networking protocols segregate the control plane from the data plane. For example, OpenFlow is a protocol which segregates the control plane to a centralized (or distributed) control plane server known as open-flow controller. According to the OpenFlow protocol, the networking devices program hardware application-specific integrated circuits (ASICs) using device driver software. The control plane is implemented at an open-flow controller. Additionally, control plane interface software resides on the networking device to communicate with the centralized control plane server. The centralized control plane server manages complex processing tasks, while the networking devices manage data plane programming tasks, for example, programming forwarding random-access memory (RAM), ternary content-addressable memory (TCAM), and policy rules for the ASICs.

However, a device driver is specific to a networking device and its underlying ASICs, and so any platform specific (e.g., hardware dependent) optimization needs to be accomplished at the networking device. Therefore, even though the current network protocols segregate the control plane from the data plane, they require the networking devices to run relatively complex software capable of programming the ASICs and performing associated hardware optimization. For example, performing in-service software upgrades (ISSUs) for data-plane programming software implemented in a networking device is a complex task because every networking device must be upgraded in a hitless manner. Additionally, current network protocols that segregate the control plane from the data plane require a high-power central processing unit (CPU) to perform any hardware dependent optimization. Also, upgrading software for each networking device requires a lot of manual intervention and that disrupts data traffic in the network. In addition to some of the tasks mentioned above requiring a high-powered CPU, the tasks may require a large amount of memory on each of the networking devices. Therefore, current networking devices in systems that segregate the control plane from the data plane can be expensive and inefficient.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

In accordance with an implementation, a management component remotely manages one or more memory components on one or more application-specific integrated circuit (ASIC) based devices, an optimization component remotely configures the one or more ASIC based devices based on a memory map of the one or more memory components on the one or more ASIC based devices, and a status component remotely monitors a state of the one or more memory components on the one or more ASIC based devices.

In accordance with another non-limiting implementation, a device includes one or more application-specific integrated circuits (ASICs), a processing component that determines memory information corresponding to the ASICs and sends the memory information to a remote server, a support component that determines information corresponding to other devices coupled to the device, and a network interface component that receives data from the remote server to configure the ASICs.

Furthermore, a non-limiting implementation provides for receiving memory information regarding one or more application-specific integrated circuit (ASIC) components by using a network interface controller, receiving flow information by using an OpenFlow agent (OFA), optimizing data entries for the one or more ASIC components in response to receiving the memory information and the flow information, and configuring the one or more ASIC components in response to the optimizing.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a block diagram of an exemplary non-limiting networking system that provides remote management and configuration of data-plane of networking devices;

FIG. 2 illustrates a block diagram of an exemplary non-limiting control server component that remotely manages and configures networking devices;

FIG. 3 illustrates a block diagram of an exemplary non-limiting control component;

FIG. 4 illustrates a block diagram of an exemplary non-limiting networking device;

FIG. 5 illustrates a block diagram of an exemplary non-limiting application-specific integrated circuit (ASIC) in a networking device;

FIG. 6 illustrates an exemplary non-limiting system that provides additional features or aspects in connection with remote data plane management and configuration of networking devices;

FIG. 7 illustrates an exemplary non-limiting system that provides centralized remote data plane management and configuration of networking devices;

FIG. 8 illustrates an exemplary non-limiting system that provides distributed remote data plane management and configuration of networking devices;

FIG. 9 is an exemplary non-limiting flow diagram for remotely managing and configuring network devices;

FIG. 10 is another exemplary non-limiting flow diagram for remotely managing and configuring ASIC devices;

FIG. 11 is an exemplary non-limiting flow diagram for providing additional features or aspects in connection with remotely managing and configuring ASIC components; and

FIG. 12 is an exemplary non-limiting flow diagram for implementing a networking device for remote management and configuration.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of the subject disclosure. It should be understood, however, that the certain aspects of disclosure may be practiced without these specific details, or with other methods, components, materials, etc. In other instances, well-known structures and devices are shown in block diagram form to facilitate describing the subject disclosure

Remote direct memory access (RDMA) is an emerging technology which allows remote access of memory in a device from another device. By implementing RDMA, a remote device can directly read/write memory of another device such that the operating system and/or an application layer of the other device can be bypassed in the read/write operation. A networking system can include a number of networking devices, such as routers and switches. The networking devices can include a specialized control plane network interface card (NIC) to provide remote direct memory access from an external server to mapped memory of application-specific integrated circuits (ASICs) on the networking devices. The ASICs on the networking devices can be hardware forwarding ASICs, which can provide network ports and/or forwarding capability for servers in a network system. The ASICs are generally programmed using a memory mapped mechanism. For example, various registers and/or forwarding tables of the ASICs can be exposed via a memory segment in a memory region of a central processing unit (CPU). By implementing RDMA protocol, ASIC memory information can be further exposed to an external server (e.g., a driver level control server) connected to the networking devices through the control plane NIC. Further the external server can optimize any entry programming to be done on the ASIC(s) of the networking device. As a result, the complexity of data plane programming is entirely managed by the external server. Further, the device driver software upgrades, if needed, can be performed by updating the external server's software.

A networking device (e.g., a switch or a router) can include a CPU, one or more ASICs and a specialized control plane NIC configured to be compliant with the RDMA protocol. The ASICs of various networking devices of a network can be responsible for (e.g. tasked with) connecting to network ports and/or forwarding data packets, thus implementing the data plane of the networking devices. The CPU of each networking device can be configured to participate in control plane operation. The CPU can also be configured to discover ASICs and provide memory mapped information about them to the external server. As such, the ASICs can be configured to properly forward data packets.

The external server can be implemented as an external control server. The external control server can be configured to execute an OpenFlow Agent (OFA) process. The OFA can be configured to establish open flow communication with an OpenFlow Controller (OFC). The specification of open-flow communication protocol can be found at OpenFlow Switch Specification, Version 1.1.0 Implemented (Wire Protocol 0x02), Feb. 28, 2011. Implementations described herein would apply to any enhancements or revisions to the open flow specification. The OFC can be configured to execute routing and/or switching related control plane applications to gather routing information. As a result, the OFC can be configured to inform the OFA how to program various flows (e.g., created from the routes).

The CPU of a particular networking device can be configured to discover presence of various ASICs (e.g., in the local system of the networking devices). For example, a peripheral component interconnect express (PCIe) method can be implemented to discover the various ASICs present in a system. The CPU can also be configured to map memory information of the ASICs to a memory segment in a local memory management unit (MMU). For example, the memory information can include, but is not limited to, memory, registers, a forwarding table and/or ternary content addressable memory (TCAM) of the ASICs. Additionally, the CPU can be configured to discover the external control server. For example, the CPU can be implemented to receive broadcasting information from the external control server. In another example, an internet protocol (IP) address of the external control server can be configured on the networking devices. As a result, the CPU can connect to the external control server to provide the external control server with memory layout information of the ASICs and/or information regarding the ASICs. For example, information regarding the ASICs can include a make, model and/or type of ASIC. Furthermore, the CPU can be configured to initialize the control plane NIC for RDMA.

The external control server can be configured to execute various device driver software updates. The device driver software can be configured to understand various types of memory information (e.g., memory, registers, a forwarding table and/or TCAM of the ASICs). The device driver software can also be configured to understand how to program the ASICs (e.g., how to program internal memory, TCAM, forwarding table, etc.). The external control server can be in constant communication with the OFC. In response to receiving packet flows to be programmed from the OFC, the external control server can proceed to program the ASICs of the networking devices by directly writing data to the forwarding table, TCAM and/or other memory of the ASICs. The external control server can program the ASICs using RDMA protocol. For example, the external control server can directly write data to the ASICs of the networking devices by sending specialized memory write instructions over the control plane NIC of the networking devices. Furthermore, the external control server can read the memory of the ASICs. The memory of a particular ASIC can indirectly read the state of various ports, flow entries and/or other communication information on the particular ASIC. As such, the external control server can receive the state of various ports, flow entries, and/or other communication information on the ASICs. Therefore, the external control server can provide the OFA with updates regarding the state of links and/or ports of the networking devices. As a result, the OFA can forward the updates to the OFC to determine routes for data packets in the networking system. The external control server can also be configured to gather statistics from the ASICs (e.g., total number of packets received by a particular port on an ASIC, total number of packets presented and/or dropped by a particular port on an ASIC, etc.). Additionally, the networking devices can be configured to forward data packet interrupts to the external control server. As such, data plane programming (e.g., ASIC programming) can be moved to the external control server from the networking devices. Therefore, no data plane programming needs to be implemented on the CPU of the networking devices.

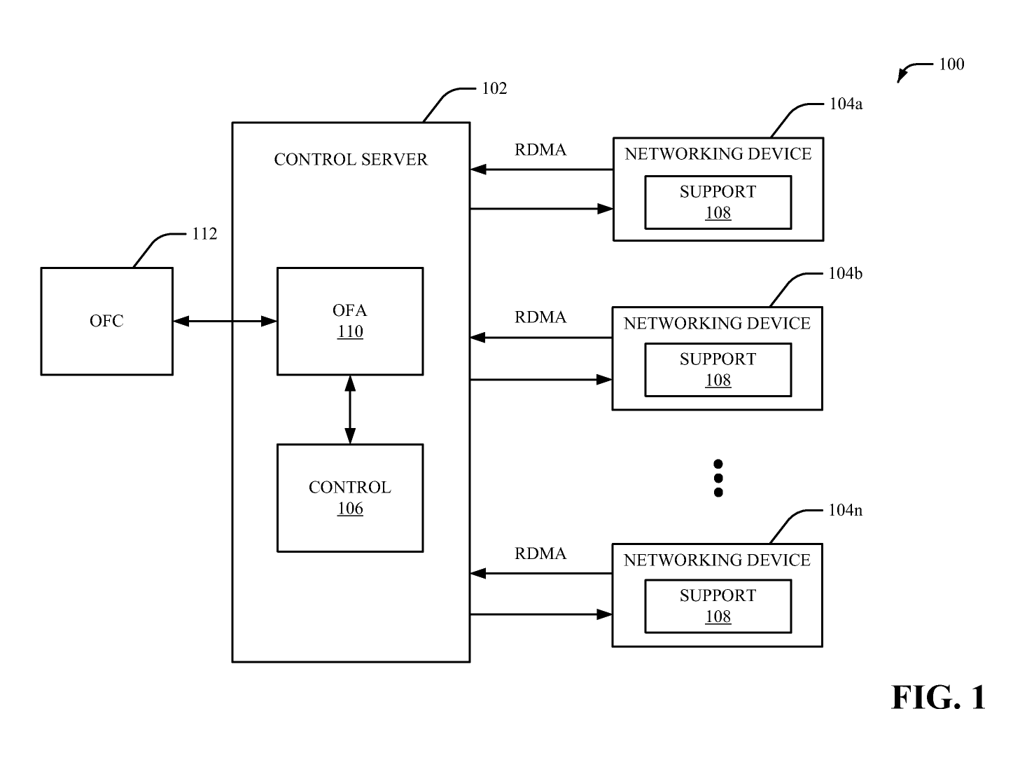

Referring initially to FIG. 1, there is illustrated an example system 100 that provides management and configuration of networking devices through a control server, according to an aspect of the subject disclosure. Specifically, the system 100 can provide a control server with a management and optimization feature that can be utilized in most any networking application. The system 100 can be employed by various systems, such as, but not limited to, network systems, ASIC systems, computer network systems, data network systems, communication systems, router systems, data center systems, server systems, high availability server systems, Web server systems, file server systems, media server systems, and the like.

In particular, the system 100 can include a control server 102 and one or more networking devices 104a-n. Generally, the control server 102 can include a memory that stores computer executable components and a processor that executes computer executable components stored in the memory. In addition, the control server 102 can include a control component 106. In one example, the control server 102 can be implemented as a controller. The control component 106 can be implemented, for example, to manage and/or optimize a data plane (e.g., forwarding plane) of the networking devices 104a-n. As such, the control server 102 can be configured to update the plurality of networking devices 104a-n (e.g., software updates, device driver updates, firmware updates, etc.). In one example, the networking devices 104a-n can be implemented as ASIC based devices (e.g., a device including ASIC components, a device including ASIC equipment, etc.). For example, the networking devices 104a-n can each include one or more ASICs. In one example, the networking devices can be implemented as ASIC devices for broadband communication. However, it is to be appreciated that the type of ASIC device can be varied to meet the design criteria of a particular system.

The control server 102 can implement inter-processor direct memory access to control the networking devices 104a-n. For example, the control server 102 can implement RDMA to access ASIC memory on the networking devices 104a-n. However, it is to be appreciated that other protocols can be implemented to establish communication between the control server 102 and the networking devices 104a-n. In one example, the networking devices 104a-n includes one or more switches. In another example, the networking devices 104a-n includes one or more routers. However, it is to be appreciated that the number and/or type of networking devices 104a-n can be varied to meet the design criteria of a particular implementation.

The control component 106 can be configured to understand various ASICs used in different networking equipment (e.g., the networking devices 104a-n). As such, different types (e.g., types of hardware, types of device brands, types of technical requirements, etc.) of networking devices 104a-n can be implemented in the system 100. Accordingly, the system 100 allows compatibility of different hardware and/or software in the networking devices 104a-n. The control component 106 can be configured to manage the networking devices 104a-n. For example, the control component 106 can understand the registers and/or a memory layout of ASICs used in the networking devices 104a-n. In one example, the control component 106 can be implemented to control ASICs in the networking devices 104a-n. The control component 106 can also be configured to provide complex optimization of the networking devices 104a-n. The control server 102 can implement RDMA to directly program the memory components of the networking devices 104a-n (e.g., memory components of ASICs). As such, complexity of programming the ASICs on the networking devices 104a-n can be removed from the networking devices 104a-n to the control server 102. Additionally, complexity of optimizations to the forwarding table and/or TCAM of the ASICs on the networking devices 104a-n can be moved from the networking devices 104a-n to the control server 102. Therefore, the networking devices 104a-n can be implemented with less memory and/or processing requirements (e.g., a cheaper CPU). Status and statistics of the networking devices 104a-n can also be offloaded to the control component 106. Additionally, interrupts generated by the networking devices 104a-n can be forwarded to the control server 102.

The networking devices 104a-n can include a support component 108. The support component 108 can be configured to provide minimal support for the control server 102 and/or the networking devices 104a-n. For example, the support component 108 can be configured to provide PCIe discovery of ASICs within a particular networking device 104a-n. As such, the support component 108 can determine the number and/or type of networking devices 104a-n in the system 100. The support component 108 can also be configured to forward interrupts generated by the networking devices 104a-n to the control server 102.

The control server 102 can also include an OpenFlow Agent (OFA) 110. The OFA 110 can be configured to determine forwarding rules for the networking devices 104a-n. The OFA 110 can communicate with the control component 106 and/or the networking devices 104a-n. The OFA 110 can also communicate with an OpenFlow Controller (OFC) 112. For example, the OFA 110 can be configured to update the OFC 112. As such, the OFA 110 can determine flows (e.g., forwarding rules) from the OFC 112 and present the flows to the control component 106. In response to receiving the flows from the OFA 110, the control component 106 can program the flows to the networking devices 104a-n via RDMA. For example, the control component 106 can directly program flows to one or more ASICs in each of the networking devices 104a-n using RDMA. In one example, the OFA 110 can be configured to update the OFC 112 with port statuses of the networking devices 104a-n managed by the control server 102.

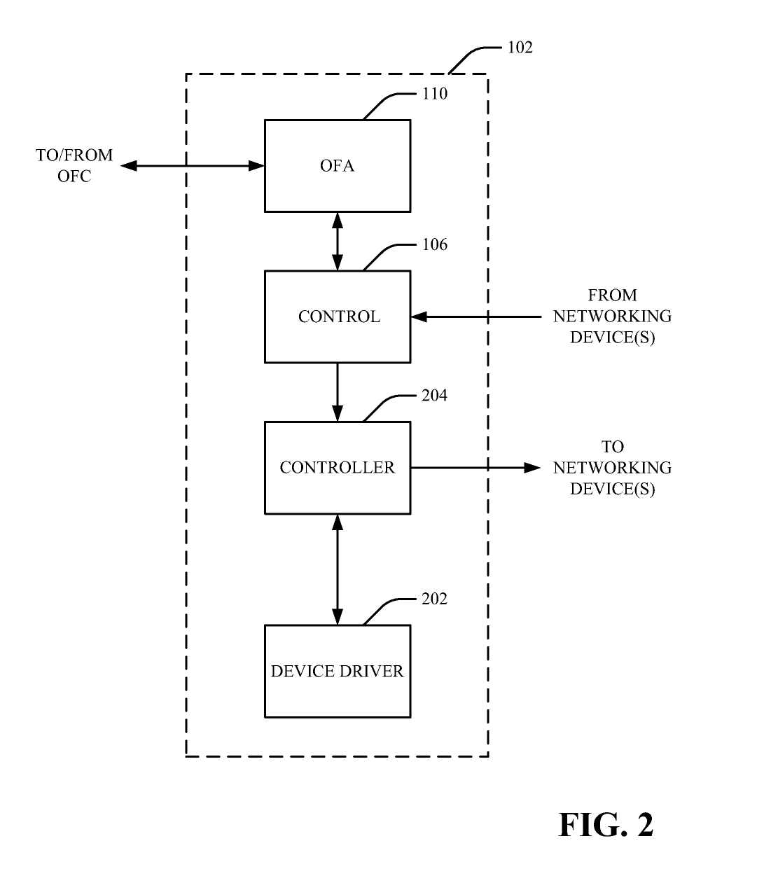

Referring now to FIG. 2, there is illustrated a non-limiting implementation of the control server 102. The control server 102 can include the control component 106, a device driver 202 and a controller 204. The control component 106 can be configured to receive data from the networking devices 104a-n. For example, the control component 106 can be configured to receive memory information (e.g., a memory table) from the networking devices 104a-n. In one example, the controller 204 can be implemented as a memory controller. For example, the controller 204 can be configured to manage access to memory components on the networking devices 104a-n. In one example, the control component 106 and the controller 204 can be implemented as a single component. In another example, the control component 106 and the controller 204 can be implemented as separate components. The OFA 110 can be in constant communication with the control component 106 and/or the OFC 112. The OFA 110 can send information from the networking devices 104a-n to the OFC 112. As a result, the OFC 112 can determine various data flows and can present the determined data flows to the OFA 110. The OFA 110 can then send flows to be programmed to the control component 106. A flow is defined according to the specification of open-flow protocol. Specifically, a flow refers to identifying a header of a packet based on certain criteria present in the packet header and identification of destination for forwarding the packet, e.g., identifying the port to forward the packet to.

In one example, the control component 106 can be configured as a driver level control. For example, the control component can provide hardware dependent optimizations for components on the networking devices 104a-n. The control component 106 can also provide software updates for components on each of the networking devices 104a-n. For example, the control component 106 can provide ASIC driver level and/or data plane forwarding entry optimization software. Additionally, the control component 106 can communicate with the networking devices 104a-n to provide management of components on the networking devices 104a-n. For example, the control component 106 can manage one or more memory components on the networking devices 104a-n. In another example, the control component 106 can optimize the networking devices 104a-n based on the configuration of one or more memory components on the networking devices 104a-n. For example, the control component 106 can optimize the networking devices 104a-n based on a memory map of one or more memory components on the networking devices 104a-n. The control component 106 and/or the controller 204 can communicate with the networking devices 104a-n (e.g., access memory components on the networking devices 104a-n) via RDMA.

The control component 106 can include one or more components (e.g., modules) to manage and/or configure the networking devices 104a-n. In one example, the control component 106 can process information from each of the networking devices 104a-n to determine approaches to configure the networking devices 104a-n (e.g., determine how to program ASICs on the networking devices 104a-n). The control component 106 can also determine (e.g., understand) a memory layout of the networking devices 104a-n. For example, the control component 106 can determine the number and/or types of memory components on each of the networking devices 104a-n. In another example, the control component 106 can determine an arrangement of memory components on the networking devices 104a-n. The control component 106 can also determine the most efficient approach to configure the memory components on the networking devices 104a-n.

The device driver 202 can include (e.g., store) software specific to each of the networking devices 104a-n. As such, the device driver 202 can update different software corresponding to each of the networking devices 104a-n. For example, a networking device 104a may require a different type of software than a networking device 104b. Therefore, driver software specific to each networking device 104a-n can be installed (e.g., updated, upgraded, etc.) on the control server. The device driver 202 can also include firmware, microcode, machine code and/or any other type of code that can be used to configure (e.g., program) the networking devices 104a-n. In one example, the device driver 202 can be implemented as an ASIC driver software component. The driver software corresponding to each of the networking devices on 104a-n, can be upgraded without disrupting other operations (e.g., forwarding data) on each of the networking devices 104a-n. The device driver 202 can be programmed to manage data plane programming according to TCAM entry format, forwarding table key and/or action format of the networking devices 104a-n.

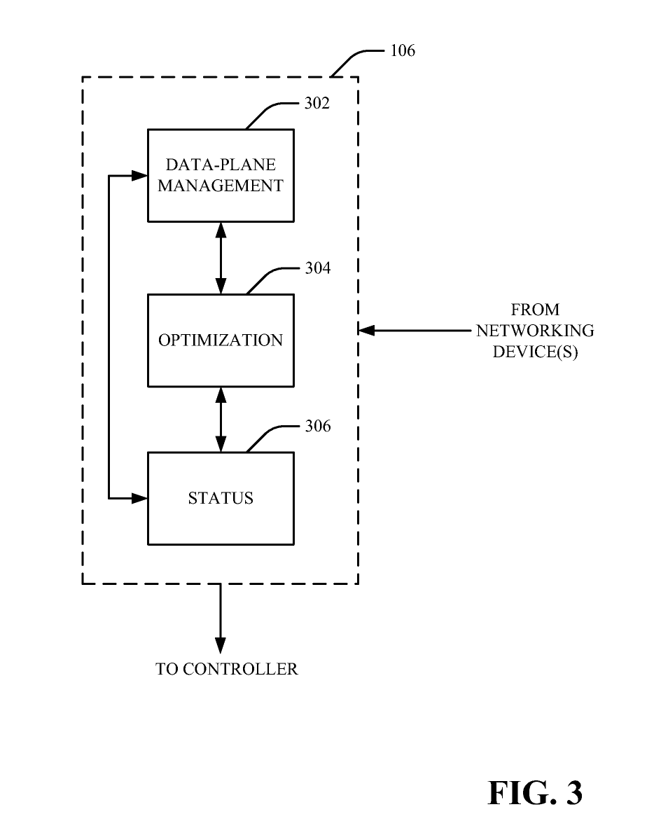

Referring to FIG. 3, there is illustrated a non-limiting implementation of the control component 106. The control component 106 can include a management component 302, an optimization component 304 and a status component 306. In one example, the management component 302, the optimization component 304 and/or the status component 306 can be configured as modules. However, it is to be appreciated that the number and/or type of components (e.g., modules) implemented in the control component 106 can be varied to meet the design criteria of a particular implementation.

In one example, the management component 302 can be configured as a data plane management component. In another example, the management component 302 can be configured as a data plane programming module. The management component 302 can be configured to manage one or more memory components on the networking devices 104a-n. For example, the management component 302 can be configured to understand various ASICs implemented in the networking devices 104a-n. As such, the management component 302 can understand various technical requirements (e.g., hardware requirements) for the networking devices 104a-n. For example, the management component can determine input requirements for the networking devices. In addition, the management component 302 can determine behavior and/or performance of components on the networking devices 104a-n. In another example, the management component 302 can determine TCAM entry formats and/or forwarding table entry formats for forwarding entry programming or for policy rule programming. The management component 302 can also understand a memory layout of ASICs on the networking devices 104a-n. Accordingly, the management component 302 can provide increased reliability in the system 100. Additionally, the management component 302 can provide more complex routing of data throughout the system 100. Furthermore, the management component 302 can provide compatibility of different networking devices 104a-n in the system 100. For example, different routers and/or switches can be implemented in the system 100. Furthermore, the management component 302 can support different routing protocols for each of the networking devices 104a-n.

The optimization component 304 can configure the networking devices 104a-n based on memory map information of memory components on the networking devices 104a-n. For example, the optimization component 304 can provide TCAM entry optimizations, policy rule optimizations, value comparator optimizations, layer 4 value comparator optimizations, forwarding entry optimizations and/or ACL optimizations. However, it is to be appreciated that other types of optimizations can be provided by the optimization component 304. The optimization component 304 can determine the best way to configure the memory components on the networking devices 104a-n. For example, the optimization component 304 can determine the best way to configure TCAM and/or a forwarding table on the networking devices 104a-n. As such, the optimization component can be implemented to increase efficiency of data transmissions in the system 100. For example, the optimization component 304 can optimize updates to the networking devices 104a-n to alleviate bottlenecks (e.g., increase performance of the system 100). Additionally, the optimization component 304 can define flow of data (e.g. transmission of data packets) to the networking devices 104a-n. For example, the optimization component 304 can determine an efficient path for data (e.g., hardware optimizations, etc.) presented to the networking devices 104a-n. The optimization component 304 can be configured to optimize data entries for the networking devices 104a-n. In one example, the optimization component 304 can be configured to optimize forwarding entries in a forwarding table and/or policy rule entries in TCAM on the networking devices 104a-n. Thus, the optimization component 304 can reduce the total number of entries to be programmed for a given set of flow entries learned from OFC. That allows the device 104a-n to support more routing entries (or flows), thereby achieving better routing capacity in each networking device and the network system as a whole. The control component 106 and/or the controller 204 can program the forwarding table and/or policy rule entries to one or more ASICs on the networking devices 104a-n using RDMA.

In one example, the status component 306 can be configured as a status/statistics gathering component. The status component 306 can monitor a state of various ports and/or related entities of ASICs on the networking devices 104a-n. The status component 306 can also be configured to determine status of ports on the networking devices 104a-n. For example, the status component 306 can determine which ports on the networking devices 104a-n are transferring data and which ports on the networking devices 104a-n are open for communication. In another example, the status component 306 can determine the status of sensors on the networking devices 104a-n. For example, the status component 306 can process data from a temperature sensor on the networking devices 104a-n. Data from the status component 306 can be used by the management component 302 and/or the optimization component 304 to manage and/or optimize the networking devices 104a-n. Additionally, the status component 306 can determine available bandwidth in the networking devices 104a-n. As such, the optimization component 304 can determine a data path with less congestion. Furthermore, the optimization component 304 can provide load balancing and/or flow control of data to the networking devices 104a-n.

The status component 306 can be configured to read the ports and/or other entity status information of ASICs on the networking devices 104a-n using RDMA. This information can be used to update the port status (e.g., whether a port is up or down). The port status can be presented to the OFA 110. The OFA 110 can then pass the port status to the OFC 112. As a result, the OFC 112 can determine routes for the modified topology of the system 100. Once the OFC 112 determines new routes, the OFC 112 can convert the new routes to flows. The OFC 112 can also instruct the OFA 110 to program the new routes (e.g., flows) on a corresponding networking devices 104a-n. For example, in response to receiving the modified flow information, the OFA 110 can notify the control server 102 to program the modified flow information to corresponding ASICs of the networking devices 104a-n using RDMA. In one example, statistics gathered from the networking devices 104a-n can be sent to remote monitoring systems for processing. In another example, a redundant (e.g., backup) controller can be implemented to increase overall system resiliency and/or performance.

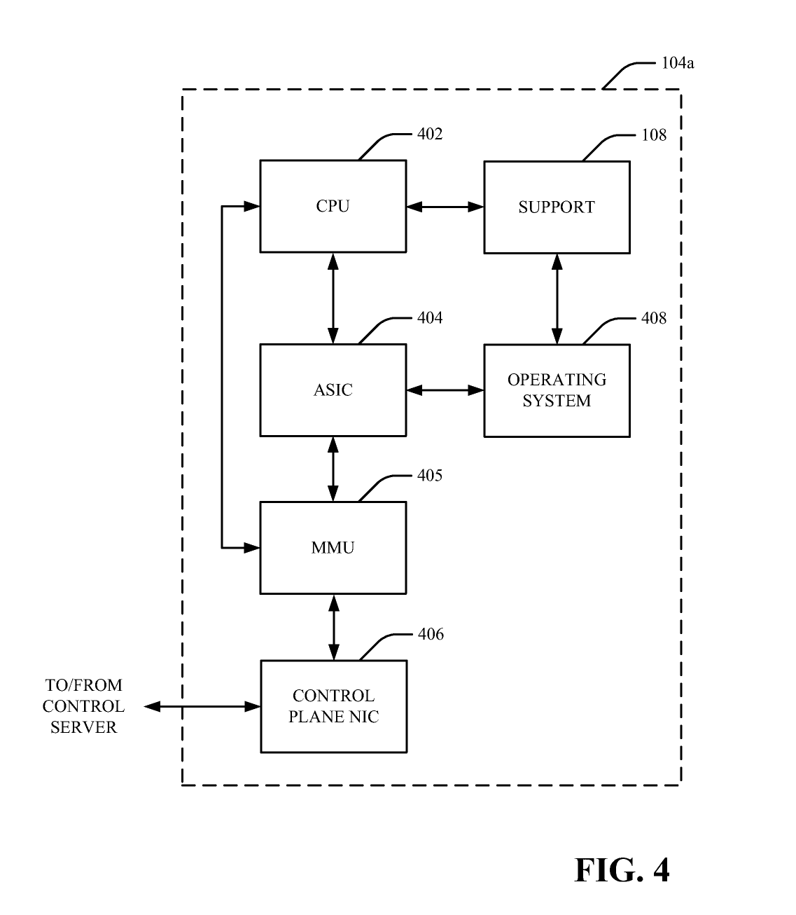

Referring now to FIG. 4, there is illustrated a non-limiting implementation of a networking device 104a. Even though the networking device 104a is shown, it is to be appreciated that the networking devices 104b-n include similar implementations. The networking device 104a can include a CPU 402, an ASIC 404, a memory management unit (MMU) 405, a control plane network interface controller (NIC) 406, an operating system (OS) 408 and the support component 108. The ASIC 404 can be implemented as one or more ASICs. The control plane NIC 406 can be configured to implement RDMA. Additionally, the control plane NIC 406 can provide control plane connectivity. For example, the control plane NIC 406 can connect to a NIC on the control server 102 (e.g., a control plane on the control server 102). The ASIC 404 in the networking device 104a can provide network ports and/or forwarding capabilities for other devices (e.g., servers coupled to the networking devices 104a-n, other servers interconnected in the system 100, other networking devices interconnected in the system 100, etc.). In one implementation, the ASIC 404 can be programmed using a memory mapped mechanism. The OS 408 can be implemented as an operating system to manage components (e.g., memory components) on the networking device 104a. In one example, the OS 408 can be configured to allow interrupts generated by the ASIC 404 to be forwarded to the control server 102 (e.g., the support component 108 can be configured to provide interrupt handling). For example, minimal changes can be made to an interrupt handler in the OS 408 to forward interrupts generated by the ASIC 404 to the control server 102. In one example, the support component 108 and the CPU 402 can be implemented as a single component. In another example, the support component 108 and the CPU 402 can be implemented as separate components. The CPU 402 and/or the control plane NIC 406 can be coupled to the MMU 405 to connect to the ASIC 404.

The ASIC 404 can include registers and/or forwarding tables and/or ternary content addressable memories (TCAMs). The registers and/or forwarding tables in the ASIC 404 can be exposed via a memory segment in a memory region of the CPU 402. For example, a memory management unit (MMU) mapping technique can be implemented to expose the registers and/or forwarding tables in the ASIC 404. By implementing RDMA protocol, the registers and/or forwarding tables in the ASIC 404 can further be exposed to the control server 102. As a result, the control server 102 can directly program registers, forwarding tables, TCAMs and/or other memory components of ASICs implemented on the networking devices 104a-n by sending instructions through RDMA protocol to the control plane NIC of a networking device 104a-n.

The support component 108 can provide PCIe discovery of other ASIC devices. For example, the support component 108 can determine the number (e.g., sum) of other networking devices (e.g., networking devices 104b-n) that are coupled with the networking device 104a to the control server 102. The support component 108 can also determine the type of networking devices (e.g., the type of ASIC devices) that are coupled with the networking device 104a to the control server 102. In one example, the support component 108 can be configured to determine the number and/or type of ASICs (e.g., make, model, etc.) that are implemented in the networking devices 104a-n. The support component 108 can also be configured to determine connection information of the control server 102. For example, the support component 108 can be configured to implement a discovery mechanism to establish communication with the control server 102. In another example, the support component 108 can be configured to establish communication with the control server 102 using an address (e.g., an IP address) of the control server 102. The address of the control server 102 can be received, for example, from storage via software of the networking devices 104a-n.

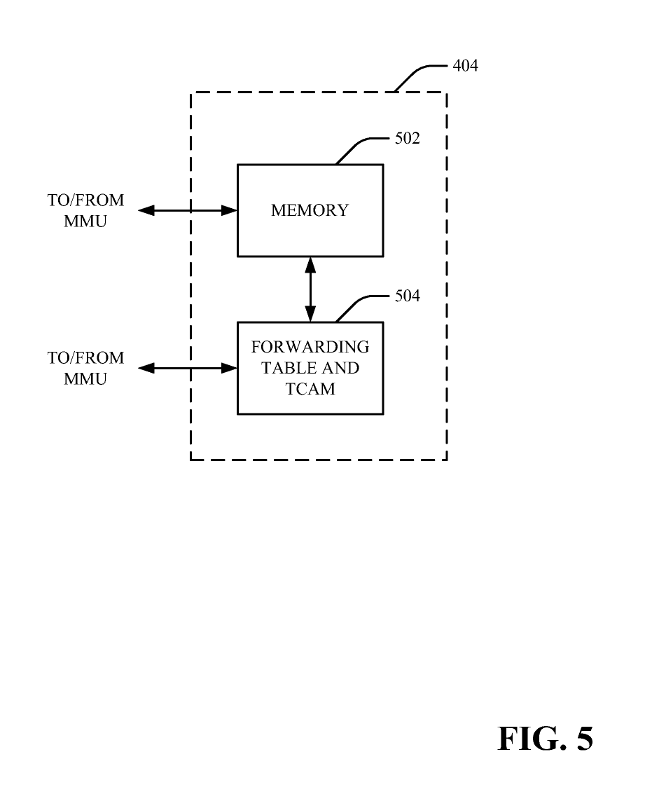

Referring now to FIG. 5, there is illustrated a non-limiting implementation of the ASIC 404. The ASIC 404 can include a memory component 502 and a forwarding table 504. In one example, the memory component 502 can be implemented as one or more registers. In another example, the memory component 502 can be implemented as a random-access memory (RAM). For example, the memory component 502 can be a static random-access memory (SRAM). In yet another example, the memory component 502 can be implemented as a ternary content-addressable memory (TCAM). However, it is to be appreciated other types of memory can additionally or alternatively be implemented in the ASIC 404. It is also to be appreciated that the number of memory components can be varied to meet the design criteria of a particular implementation. In one example, the forwarding table 504 can be implemented as one or more forwarding tables. In one implementation, the memory component 502 can be configured to program the forwarding table 504.

The memory component 502 and/or the forwarding table 504 can be exposed to the control server 102. By implementing RDMA protocol, the memory component 502 can be configured (e.g., programmed) by the control server 102 (e.g., the optimization component 304 or the controller 204). As such, device driver and/or hardware level optimizations for the ASIC 404 can be performed by the control server 102. The control server 102 can access the memory component 502 using RDMA protocol. For example, the control server 102 can access the memory component 502 through a control plane NIC interface. When the same policy rules are configured on networking devices 104a-n using the same type of ASICs, the control server 102 can perform caching to save cycles in deriving entries to be programmed on the ASIC 404 on the networking devices 104a-n. For example, the control server 102 can compute policy rules per policy TCAM format of a particular ASIC (e.g., the ASIC 404) on the networking devices 104a-n. The policy rules can be stored (e.g., in a cache memory on the control server 102). Therefore, the control server 102 can directly program other ASICs on other networking devices by reading entries stored on the control server 102 instead of computing all the entries again for each ASIC on the networking devices 104a-n.

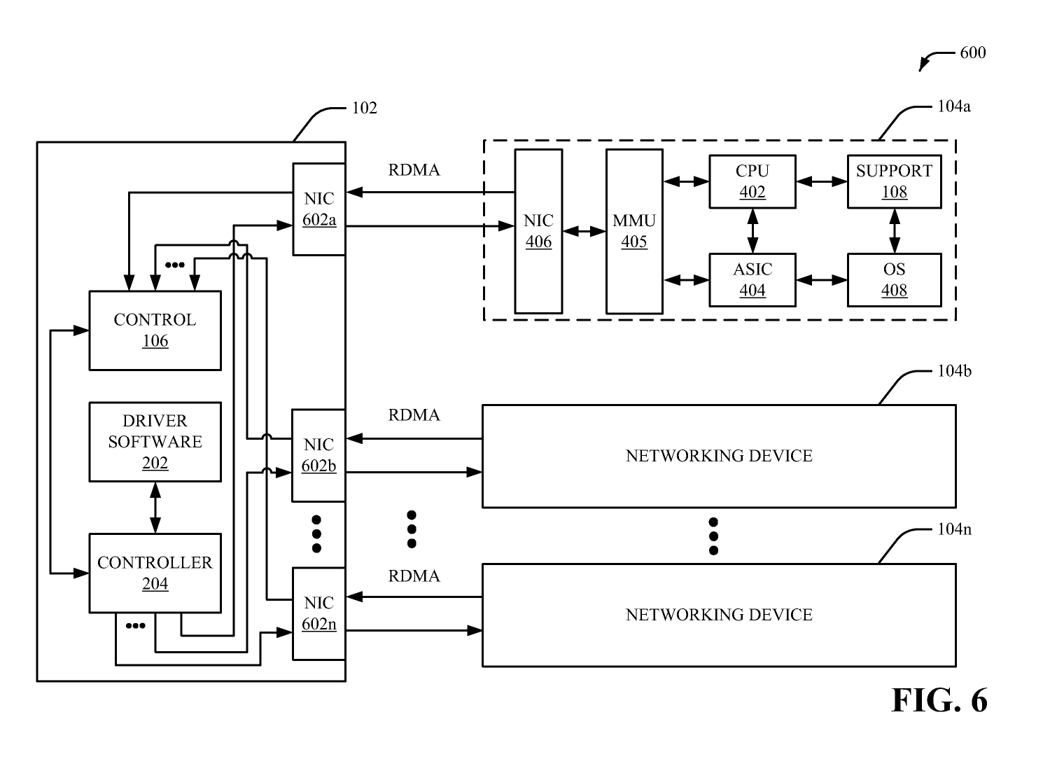

Referring to FIG. 6, there is illustrated a system 600 that provides data plane management and configuration of networking devices using a control server. The control server 102 can include one or more NICs 602a-n. Each of the networking devices 104a-n can also include a NIC 406. The NICs 602a-n and the NIC 406 can provide control plane connectivity (e.g., an interface) between the control server 102 and the networking devices 104a-n. It is to be appreciated that the number of NICs 602a-n does not need to match the number of networking devices 104a-n. For example, a single NIC 602a on the control server 102 can connect to multiple networking devices 104a-n (e.g., a NIC 406 on multiple networking devices 104a-n). In one example, the NICs 602a-n and the NIC 406 can be configured to support RDMA protocol. The control server 102 can also provide device driver configuration of the networking devices 104a-n. Additionally or alternatively, the control server 102 can also provide platform specific (e.g., hardware dependent) optimization of the networking devices 104a-n. Therefore, the control server 102 can provide the device driver and/or hardware level optimizations. Thus, the control server 102 can provide the data-plane implementation for the networking devices 104a-n. Also, the control plane processing for the networking devices 104a-n can be implemented on the open flow controller 112, which is used in conjunction with the control server 102. For example, the open flow controller 112 can support routing, address learning, policy rule compilation, etc. The open flow controller 112 can, in turn, provide information in the form of rules to the control server 102. The control server 102 can run (or execute) the open flow agent software. Therefore, the control server 102, in turn, can program the ASICs on the networking devices 104a-n. As such, the burden on the CPU 402 implemented on the networking devices 104a-n can be reduced, allowing the CPU 402 to be implemented with less memory and/or processing requirements. The NIC 406 can exchange RDMA protocols with the NICs 602a-n to facilitate direct reads/writes from the control server 102 to the ASIC 404 on each of the networking devices 104a-n. Accordingly, RDMA protocol exchanges between the NIC 406 and the NICs 602a-n can be implemented to facilitate configuration of one or more ASICs on the networking devices 104a-n.

The control server 102 can obtain a global framework of components on the system (e.g., network) 600 from the networking devices 104a-n. Therefore, the control server 102 can perform efficient computation of multiple networking devices. As such, the control server 102 can perform optimizations on policy rules for components (e.g., hardware) implemented on the networking devices 104a-n. The results of the optimizations can be stored (e.g., in a cache memory) and distributed to other networking devices (e.g., ASICs). For example, the same policy rules can be configured on multiple networking devices 104a-n. As such, stored optimizations from a networking device 104a can be distributed to other networking devices 104b-n.

The system 600 allows driver software corresponding to the networking devices 104a-n to be updated by updating the software running at the control server 102. As such, upgrades (e.g., software upgrades) to the networking devices 104a-n can be more efficient. For example, the networking devices 104a-n can continue to forward data (e.g., forward data to servers) while control software is being updated on the control server 102. Additionally, after a software upgrade, the control server 102 can determine a hardware state on the networking devices 104a-n by reading the state of the ASIC 404 through RDMA. However, it is to be appreciated that the system 600 can alternatively implement a different protocol to establish communication between an ASIC device (e.g., the networking devices 104a-n) and a remote server (e.g., the control server 102).

Furthermore, in service software upgrade (ISSU) can also be supported by the system 600. During the upgrade of the driver-software (corresponding to the networking devices 104a-n) on the control server 102, the networking devices 104a-n are not disrupted and the ASICs on the networking devices 104a-n can continue to forward data traffic. Accordingly, complex operations to manage and/or optimize the networking devices 104a-n can be executed by the control server 102.

In one example, multiple instances of the control server 102 can run in the system 600 in a redundant mode or as a distributed hash ring. The networking devices 104a-n can choose any of the available control servers to provide a particular control server with the data plane management functionality. When a particular control server crashes or is otherwise removed, the networking devices 104a-n can then negotiate with another control server (e.g., a new control server). Therefore, the networking devices 104a-n can request the data plane management be provided by the new control server.

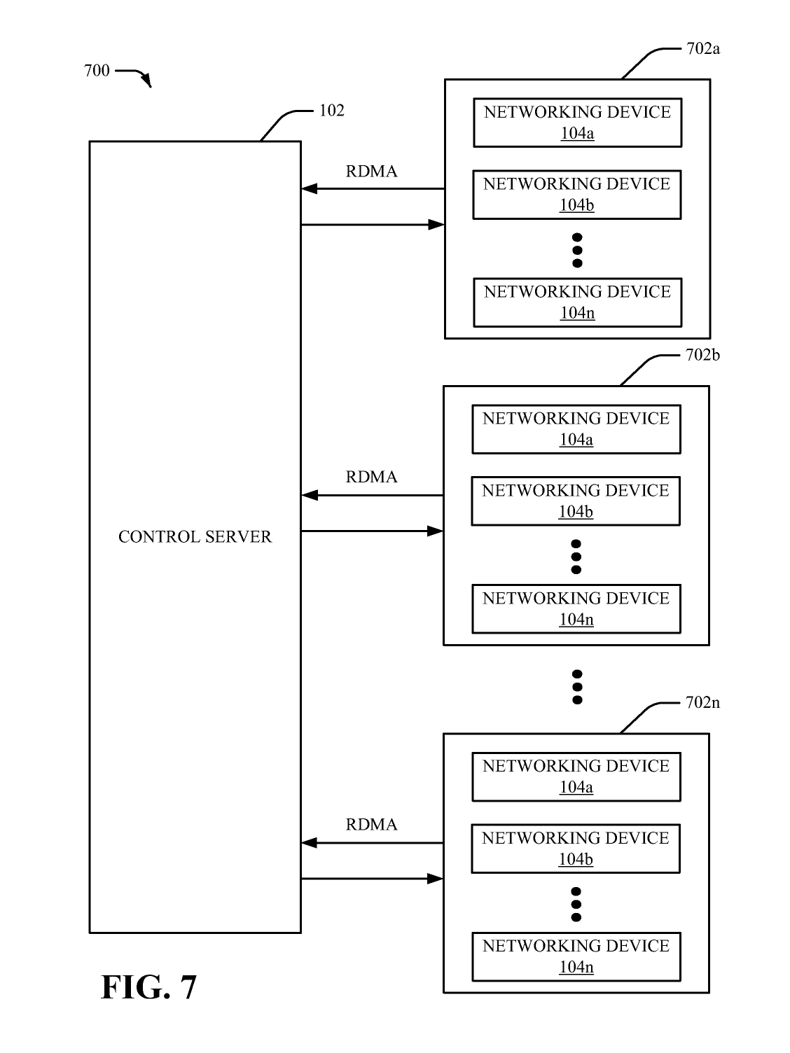

Referring to FIG. 7, there is illustrated a system 700 that provides centralized data plane management and configuration of networking devices through a control server. In one example, the system 700 is implemented as a data center system. However, it is to be appreciated that the system 700 can be implemented in any networking system. The system 700 can include a group of networking devices 702a-n. For example, the group of networking devices 702a-n can each be implemented as a cluster. Each group of networking devices 702a-n can include one or more of the networking devices 104a-n. It is to be appreciated that the networking devices 104a-n can be different for each group of networking devices 702a-n. The control server 102 can manage and configure each group of networking devices 702a-n and the networking devices 104a-n in each group of networking devices 702a-n. As such, the control server 102 can be implemented as a centralized control server. Therefore, the control server 102 can manage and configure groups of networking devices at different locations. For example, the group of networking devices 702a can be implemented in one location and the group of networking devices 702b can be implemented in a different location. However, it is to be appreciated that the locations of the group of networking devices 702a-n can be varied to meet the design criteria of a particular implementation. The control server 102 can remotely access the group of networking devices 702a-n, and the networking devices 104a-n, by implementing RDMA.

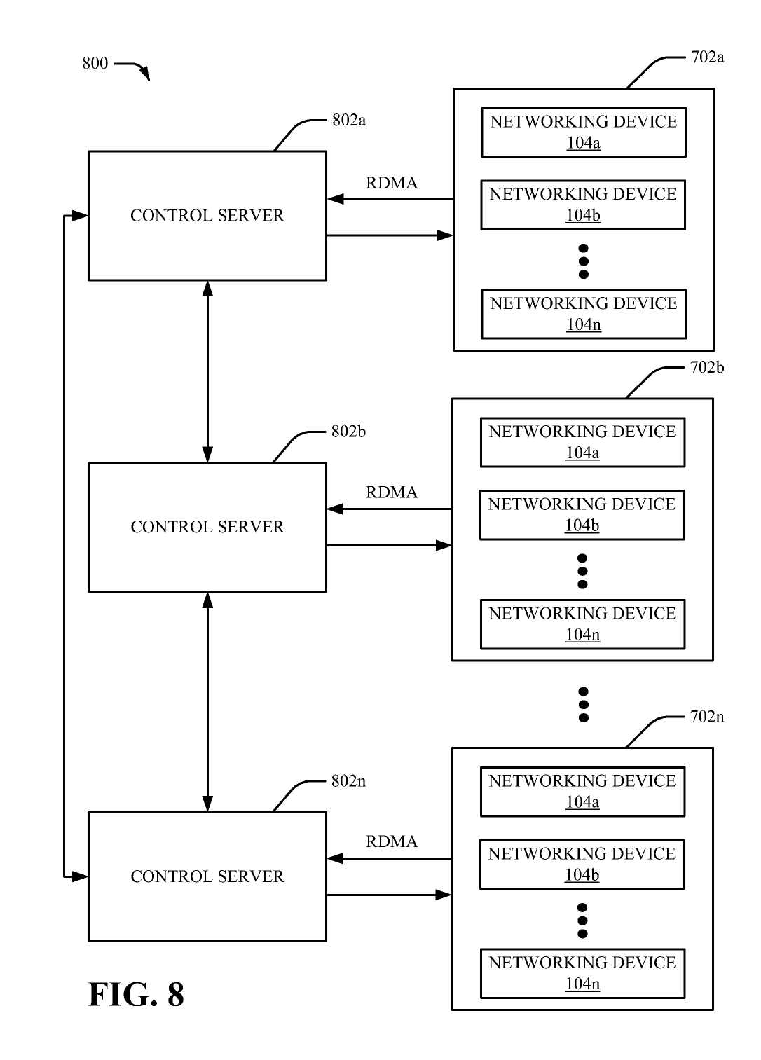

Referring to FIG. 8, there is illustrated a system 800 that provides distributed data plane management and configuration of networking devices through one or more control servers. In one example, the system 800 is implemented as a data center system. However, it is to be appreciated that the system 800 can be implemented in any networking system. The system 800 can include the group of networking devices 702a-n. Each group of networking devices 702a-n can include one or more of the networking devices 104a-n. It is to be appreciated that the networking devices 104a-n can be different for each group of networking devices 702a-n. Control servers 802a-n can manage and configure a particular group of networking devices 702a-n and networking devices 104a-n. Each of the control servers 802a-n can be implemented as the control server 102. Additionally, each of the control servers 802a-n can communicate with the other control servers 802a-n to manage and configure the group of networking devices 702a-n. As such, the control servers 802a-n can manage and configure a group of networking devices at different locations. For example, the group of networking devices 702a can be coupled to the control server 802a in one location and the group of networking devices 702b can be coupled to the control server 802b in a different location. However, it is to be appreciated that the locations of the group of networking devices 702a-n and/or the control servers 802a-n can be varied to meet the design criteria of a particular implementation. It is also to be appreciated that the arrangement of the group of networking devices 702a-n and/or the control servers 802a-n can be varied to meet the design criteria of a particular implementation. The control servers 802a-n can remotely access a particular group of networking devices 702a-n, and the networking devices 104a-n, by implementing RDMA.

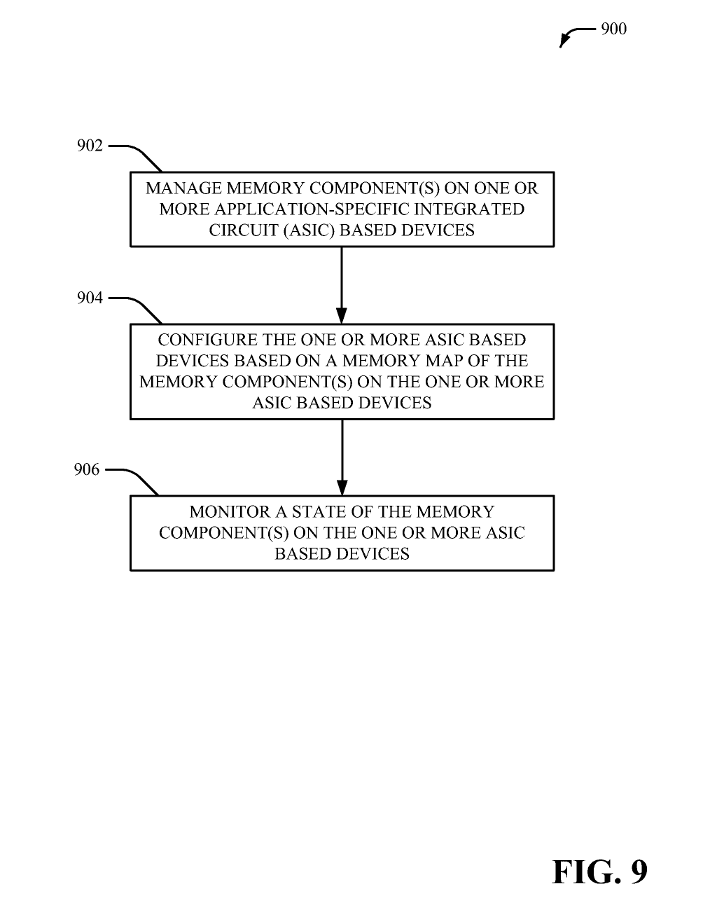

FIGS. 9-12 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 9 there illustrated is a methodology 900 for remotely managing and configuring networking devices, according to an aspect of the subject innovation. As an example, methodology 900 can be utilized in various networking applications, such as, but not limited to, network systems, ASIC systems, computer network systems, data network systems, communication systems, router systems, data center systems, server systems, high availability server systems, Web server systems, file server systems, media server systems, etc. Moreover, the methodology 900 is configured to provide remote management and configuration of networking devices. Specifically, methodology 900 enables a remote control server to manage and optimize one or more networking (e.g., ASIC) devices.

At 902, one or more memory components on one or more application-specific integrated circuit (ASIC) based devices can be managed (e.g., using a management component 302). For example, the management component 302 can determine a memory layout and/or the type memory components on the ASIC based devices. At 904, the one or more ASIC based devices can be configured (e.g., using an optimization component 304) based on a memory map of the one or more memory components on the one or more ASIC based devices. For example, the optimization component 304 can update the one or more memory components based on a memory map of the one or more memory components. At 906, a state of the one or more memory components on the one or more ASIC based devices can be monitored (e.g., using a status component 306). The status component 306 can also determine the status of network ports (e.g., which network ports are available to transfer data) on the ASIC based devices. In one example, the state of the one or more memory components on the one or more ASIC based devices can be monitored by indirectly accessing one or more associated memory registers of an ASIC.

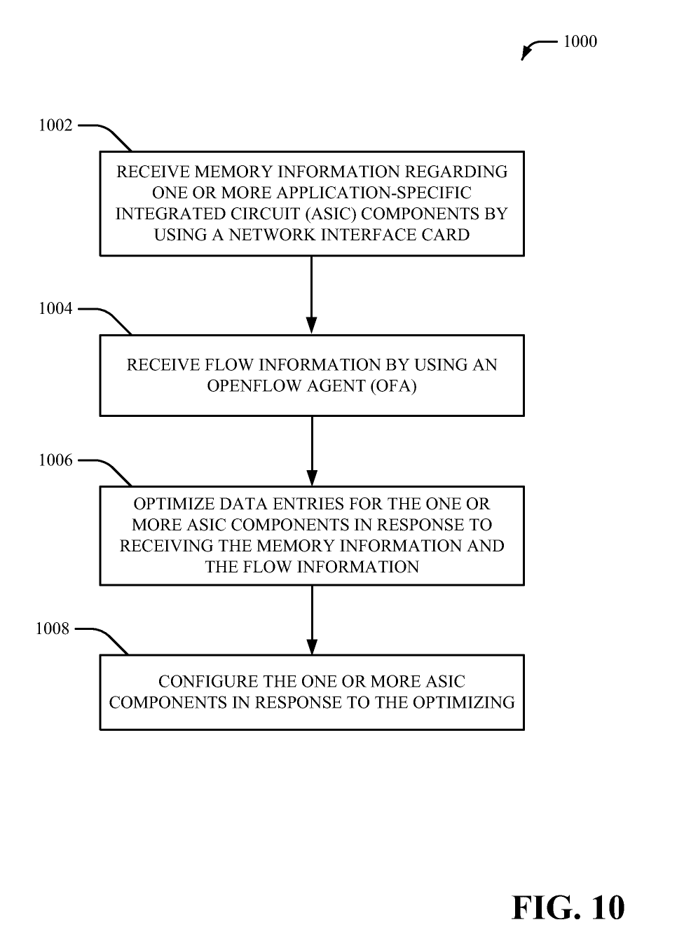

Referring to FIG. 10 there illustrated is a methodology 1000 for implementing a control server 102, according to an aspect of the subject innovation. At 1002, memory information regarding one or more ASIC components can be received (e.g., by a control server 102) by using a network interface card. For example, a remote server can receive memory information about an ASIC component from a CPU on a networking device. The memory information about the ASIC component can include, for example, information about various registers and/or TCAMs and/or forwarding tables on the ASIC component. Additionally, the CPU can determine the number of ASIC components and/or the type of ASIC components coupled to the remote server. At 1004, flow information can be received (e.g., by a control server 102) by using an OpenFlow agent (OFA). For example, the OFA 110 can receive flow information. At 1006, data entries for the one or more ASIC components can be optimized (e.g., by an optimization component 304) in response to receiving the memory information and the flow information. For example, forwarding entries to be programmed on the ASIC components can be optimized based on hardware of the ASIC components. In one example, the remote server can determine a memory layout (e.g., forwarding entry table format, TCAM format) of the ASIC components to optimize entries to be programmed to the ASIC components. In another example, the remote server can determine an optimal flow of data to the ASIC components. At 1008, the one or more ASIC components can be configured (e.g., by a controller 204) in response to the optimizing. For example, the controller 204 can program the ASIC components. In one example, RDMA protocol can be implemented to directly configure (e.g., program) memory components of the ASIC components. For example, data entries can be programmed onto the ASIC components using RDMA protocols.

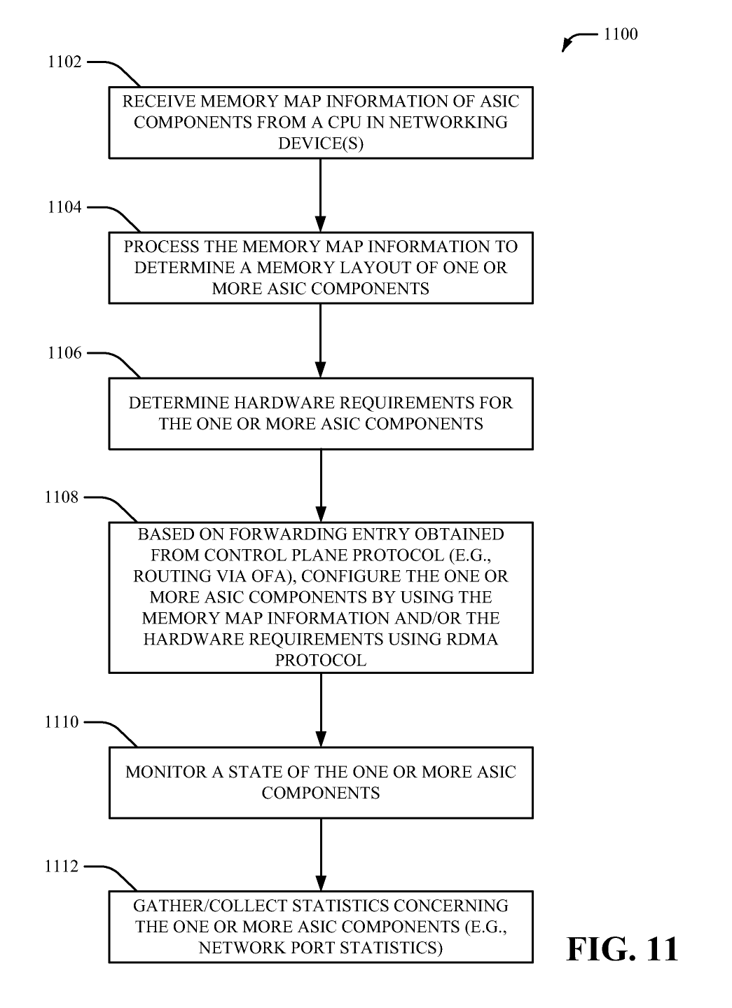

Referring to FIG. 11 there illustrated is another methodology 1100 for implementing a control server 102, according to an aspect of the subject innovation. At 1102, memory map information of one or more ASIC components can be received (e.g., by a control server 102) from a CPU in one or more networking devices. At 1104, the memory map information can be processed (e.g., by a management component 302) to determine a memory layout of one or more ASIC components. For example, the memory map information can be processed based on the make, model, and/or type of the one or more ASIC components. At 1106, hardware requirements for the one or more ASIC components can be determined. For example, technical characteristics (e.g., TCAM entry format, forwarding table entry format) of the one or more ASIC components can be determined. At 1108, based on a forwarding entry obtained from control plane protocol (e.g., routing entries via OFA), the one or more ASIC components can be configured (e.g., by an optimization component 304) by using the memory map information and/or the hardware requirements using RDMA protocol. In one example, the device driver can be capable of programming the one or more ASIC components. The OFA 110 can communicate with the OFC 112 to obtain flow entries to be programmed on the one or more ASIC components. The optimization component 304 can optimize the forwarding table and/or TCAM policy rule entries. As a result, the forwarding table and/or TCAM policy rule entries can be programmed on the one or more ASIC components by writing directly to one or more memory components on the one or more ASIC components using RDMA. At 1110, a state of the one or more ASIC components can be monitored (e.g., by a status component 306). At 1112, statistics concerning the configuration of the one or more ASIC components (e.g., network port statistics) can be gathered and/or collected (e.g., by a status component 306). For example, packet ingress and/or egress statistics of one or more network ports in a particular ASIC component can be gathered and/or collected.

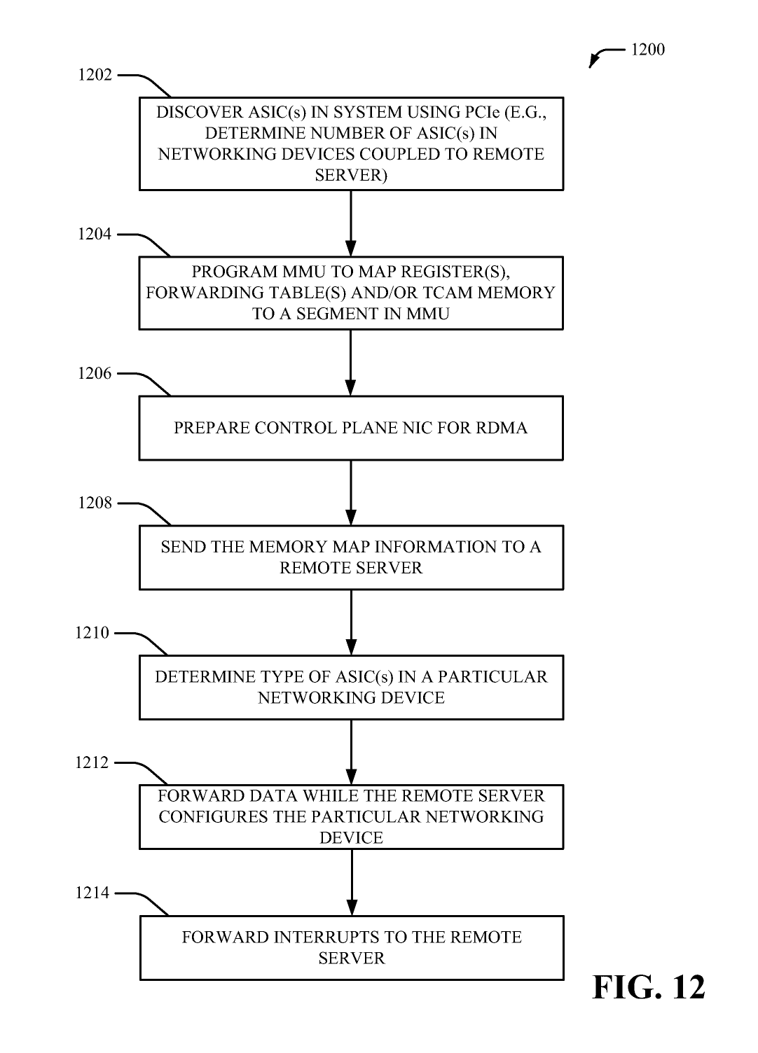

Referring to FIG. 12 there illustrated is a methodology 1200 for implementing networking devices 104a-n for remote management and configuration, according to an aspect of the subject innovation. At 1202, one or more ASICs in a system can be discovered (e.g., by a support component 108) using PCIe. For example, the number of ASICs in one or more networking devices coupled to a remote server can be determined. In one example, information regarding the number of ASICs can be used to elect a different control server if a CPU on a particular networking device determines that a particular control server is overloaded with serving other networking devices. At 1204, a MMU can be programmed (e .g, by a CPU 402) to map one or more registers, one or more forwarding tables, and/or TCAM memory to a segment in the MMU. At 1206, a control plane NIC can be prepared (e.g., by a CPU 402) for RDMA. At 1208, the memory map information can be sent (e.g., from a CPU 402) to a remote server. At 1210, the type of ASICs in a particular networking device can be determined (e.g., by a support component 108). At 1212, data can be forwarded (e.g., by a networking device 104a-n) while the remote server configures the particular networking device. At 1214, interrupts can be forwarded (e.g., by a support component 108) to the remote server.

What has been described above includes examples of the implementations of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated implementations of the subject disclosure is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not illustrated herein.

In regards to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A device, comprising:
a processor;
a memory storing instructions that, when executed by the processor, cause the processor to:
obtain memory information for a remote network device that includes one or more memory components on one or more application-specific integrated circuit (ASIC) based devices (ASIC devices), the network device including a network interface controller (NIC) compliant with a remote direct memory access (RDMA) protocol;
determine, from the memory information, a memory layout and a component type for each of the one or more memory components on the one or more ASIC devices of the remote network device;
monitor a state of the one or more memory components on the one or more ASIC devices of the remote network device;
derive one or more data entries for the one or more ASIC devices using the memory layout, the component type, and the monitored state of the one or more memory components on the one or more ASIC devices of the remote network device, wherein the one or more data entries include one or more of: a forwarding entry, a policy rule entry, a flow entry, a routing entry, and a ternary content-addressable memory (TCAM) entry; and
remotely configure the one or more ASIC devices by directly writing the derived data entries, using the memory layout, to the one or more memory components on the one or more ASIC devices of the remote network device using the RDMA protocol.

2. The device of claim 1, wherein the device is a control server.

3. The device of claim 1, wherein the device is coupled to the network device through a control plane network.

4. The device of claim 1, the memory further storing instructions that, when executed by the processor, cause the processor to optimize the data entries for the one or more ASIC devices.

5. The device of claim 1, the memory further storing instructions that, when executed by the processor, cause the processor to remotely program a forwarding table and a ternary-content-addressable memory (TCAM) directly on the one or more ASIC devices using the RDMA protocol.

6. The device of claim 1, the memory further storing instructions that, when executed by the processor, cause the processor to receive interrupts generated by an operating system implemented on the network device.

7. The device of claim 1, the memory further storing instructions that, when executed by the processor, cause the processor to perform optimizations on policy rules and forwarding entries of the one or more ASIC devices and store the optimizations for distribution to other ASIC based devices.

8. The device of claim 1, the memory further storing instructions that, when executed by the processor, cause the processor to format the data entries according to at least one of a TCAM entry format, a forwarding table key, and an action format of the one or more ASIC devices.

9. (canceled)

10. (canceled)

11. The device of claim 1, the memory further storing instructions that, when executed by the processor, cause the processor to remotely monitor statistics of the one or more memory components.

12. The device of claim 1, the memory further storing instructions that, when executed by the processor, cause the processor to execute an OpenFlow agent (OFA) that determines forwarding rules for the network device.

13. The device of claim 12, wherein the OFA updates an OpenFlow controller with port statuses of one or more network devices managed by the device.

14. The device of claim 12, the memory further storing instructions that, when executed by the processor, cause the processor to present port status information to the OFA.

15. A method, comprising:
employing at least one processor executing computer executable instructions embodied on at least one non-transitory computer readable medium to perform operations comprising:
obtaining memory information for a remote network device that includes one or more memory components on one or more application-specific integrated circuit (ASIC) based-devices (ASIC devices), the network device including a network interface controller (NIC) compliant with a remote direct memory access (RDMA) protocol;
determining, from the memory information, a memory layout and a component type for each of the one or more memory components on the one or more ASIC devices of the remote network device;
monitoring a state of the one or more memory components on the one or more ASIC devices of the remote network device;
deriving one or more data entries for the one or more ASIC devices using the memory layout, the component type, and the monitored state of the one or more memory components on the one or more ASIC devices of the remote network device, wherein the one or more data entries include one or more of a forwarding entry, a policy rule entry, a flow entry, a routing entry, and a ternary content-addressable memory (TCAM) entry; and
configuring, remotely, the one or more ASIC devices by directly writing the derived data entries, using the memory layout, to the one or more memory components on the one or more ASIC devices of the remote network device, using the RDMA protocol.

16. The method of claim 15, wherein deriving one or more data entries for the one or more ASIC devices includes optimizing the data entries.

17. The method of claim 16, wherein optimizing includes determining hardware requirements for the one or more ASIC devices.

18. The method of claim 17, wherein determining hardware requirements includes determining TCAM entry formats and forwarding table entry formats for forwarding rule and policy rule programming.

19. (canceled)

20. The method of claim 15, wherein the configuring includes installing a device driver capable of programming the one or more ASIC devices.

21. (canceled)

22. The device of claim 1, the memory further storing instructions that, when executed by the processor, cause the processor to:
send the memory information to a remote server;
determine information corresponding to other devices coupled to the device; and
receive data from the remote server to configure the ASICs.

23.-25. (canceled)

26. The device of claim 22, wherein the information corresponding to other devices includes a sum of other devices coupled to the device.

27. The device of claim 22, wherein the information corresponding to other devices includes types of other devices coupled to the device.

28. The device of claim 22, the memory further storing instructions that, when executed by the processor, cause the processor to forward interrupts received from the one or more ASIC devices to the remote server.

29. The device of claim 1, the memory further storing instructions that, when executed by the processor, cause the processor to apply an update to the one or more ASIC devices, wherein the update is one of: a software update, a device driver update, and a firmware update.

30. The method of claim 15, further employing the at least one processor to perform operations comprising: applying an update to the networking device, wherein the update is one of: a software update, a device driver update, and a firmware update.

31. The method of claim 15, further employing the at least one processor to perform operations comprising: remotely programing a forwarding table and a ternary-content-addressable memory (TCAM) directly on the one or more ASIC devices using the RDMA protocol.

32. The method of claim 15, further employing the at least one processor to perform operations comprising: formatting the data entries according to at least one of a TCAM entry format, a forwarding table key, and an action format of the one or more ASIC based network devices.

33. The method of claim 15, further employing the at least one processor to perform operations comprising: remotely monitoring statistics of the one or more memory components.

34. The device of claim 1, the memory further storing instructions that, when executed by the processor, cause the processor to determine, from the memory information, an entry format to use for the derived data entries.

35. The method of claim 15, further comprising determining, from the memory information, an entry format to use for the derived data entries.
